(19) United States
(12) Patent Application Publication
(10) Pub. No.: US 2026/0222433 A1
(43) Pub. Date: Jul. 30, 2026

(54) Recursive Anomaly Detection in Communication Networks

(71) Applicant: Telefonaktiebolaget LM Ericsson (publ), Stockholm (SE)

(72) Inventors: Attila Mitcsenkov, Budapest (HU); Alexander Biro, Budapest (HU); Vilma Orgoványi, Budapest (HU)

(21) Appl. No.: 19/150,146

(22) PCT Filed: Feb. 8, 2023
(86) PCT No.: PCT/IB2023/051134

§ 371 Date: Jul. 22, 2025

(51) Int. Cl. H04L 9/40; H04L 43/0805

(52) U.S. Cl. CPC H04L 63/1425; H04L 43/0805

(57) ABSTRACT

Underperforming network segments and other network anomalies are detected using recursive anomaly detection based on separation of communication sessions into homogenous groups according to different dimensions. After collecting KPIs from various network segments and subscriber sessions, attributes corresponding to different dimensions of interest are assigned to the KPIs. During the recursive anomaly detection, the assigned attributes are used to separate the metrics into homogenous groups based on one or more dimensions of interests. Anomaly detection, also referred to as outlier detection, is performed to determine whether a specific homogenous group identified contains anomalous KPIs. These anomalous KPIs may indicate underperforming network segments or elements, interworking issues, or other network anomalies.

### TECHNICAL FIELD

The present disclosure relates generally to data analytics systems for network monitoring and, more particularly, to techniques for recursive anomaly detection to isolate network anomalies indicative of undeforming network segments and interworking problems.

### BACKGROUND

Network and subscriber analytics systems, which are part of the network management domain, monitor and analyze service and network quality at the subscriber level in mobile networks. Analytics systems are used for different operational groups by mobile network operators, such as Network Operation Centers (NOCs) and Service Operation Centers (SOCs), and by groups responsible for network optimization engineering and network planning.

In analytics systems, key performance indicators (KPIs) calculated based on node and network events and counters are continuously monitored in NOCs. Event-based analytics systems are also monitored in (SOCs) in order to monitor quality of the wide variety of services used in network level, as well as to monitor customer experience at the individual per subscriber level. These tools are widely used in customer care and other business scenarios.

Standard telecommunications analytics systems operate on fault, configuration, accounting, performance, security (FCAPS) data. The detection of operational issues mainly relies on fault management (FM) events where individual network elements themselves are able to report their own failures, or performance management (PM) counters where pre-defined alarming thresholds are applied to indicate performance issues.

More advanced analytics solutions, such as Ericsson Expert Analytics (EEA), operate on end-to-end correlated multi-domain network data sources, and target user experience analytics. This system combines information from the packet core, radio network or services, and applications, such as the Internet Protocol (IP) Multimedia subsystem (IMS). Because telecommunication networks are increasingly complex, multi-domain, and multi-dimensional, correlation is required to understand interworking issues and the contribution of various network elements and layers to performance degradations. In many cases, there is no single network element being responsible for the observed problems.

Fast reaction in network management is based on real-time analytics requiring real-time collection and correlation of characteristic node and protocol events from different radio and core network nodes, probing signaling interfaces, and the user-plane traffic as well. In addition to the data collection and correlation functions that handle this large amount of heterogenous data from many sources, an analytics system requires advanced databases, rule engines, and big data analytics platforms. The amount of network and node events, especially that containing detailed user plane metrics, is large, and the event rate can be in the order of Gbit/s in a larger network.

Processing such a large amount of data in real-time requires quick data evaluation and storing of relevant and aggregated data. In order to detect service, node and network issues, and to isolate the root cause for large amounts of sessions, mobile network operators network FM metrics are created and analyzed. These FM metrics are prioritized and handed over to network operation engineering teams tasked with correctio of networking issues.

Network engineering issues and problems typically lead to persistent or frequent performance degradation in certain segments of the network, and/or user experience degradation for a subset of subscribers and sessions. However, isolating the exact issues impacting performance or experience metrics in a network environment with high dimensional possibilities is not straightforward. Except for a few major, drastic network issues, performance degradations are not easy to detect and require a properly chosen filtered view of the network.

One approach to fault detection and troubleshooting involves manual searching for erroneous elements using the wide variety of filtering options and network monitoring and analytics tools to identify underperforming network elements with inferior key performance indicators (KPIs). This approach starts with discovery of underperforming network segments, excluding factors that are not contributing to the performance degradation, and finally isolating sources of the observed degradation. In the case of complex, wide coverage tools, this approach provides the ability to investigate a variety of network issues. However, finding previously unknown problems is next to impossible if only a random search is used.

Another approach to problem detection is using fixed alarming thresholds for various KPIs and filters in the network to detect problematic scenarios without the need for manual searching. However, if the thresholds are low, the system becomes overly sensitive, i.e., overloaded with a high number of alarms. On the other hand, if the thresholds are too high, only the highly serious issues will be detected (typically later than expected). Additionally, the network is heterogeneous in many senses so that defining an alarming threshold for all cells, services, nodes, etc. is nearly impossible, or will always highlight those aspects that naturally have lower performance (e.g., in cells with bad terrain conditions with always have lower signal quality, or less demanding services will always have lower throughput figures).

Anomaly detection approaches overcome the problem of pre-defined alarming thresholds by setting alarms based on the observed distribution of KPIs, and indicating whether certain values are outliers compared to their typical behavior. This approach works well when there is a degradation in performance from typical values, but in case of network elements with consistent, persistent performance degradations, the comparison to their typical behavior does not help the detection.

Learning the behavior of the network, especially relating to persistent, non-time dependent behavior and load dependence of metrics/KPIs, and the distinction between comparable and non-comparable objects in the network is a highly important aspect when targeting and isolating abnormal scenarios. Any given metric, network element or subscriber group might have different levels in peak hours and silent hours, daytime or during the night, working days or weekends.

The underlying data for fault detection routines, manual search, alarming threshold, or anomaly detection-based solutions, are typically one-dimensional node logs, i.e., uncorrelated data sources, which limit the scope to failures with directly measurable impact on single, monitored network elements (counters). The multi-domain correlation of data sources helps to isolate issues and reveal failures and interworking problems in the multi-dimensional system of a telecommunication network (examples: configuration settings causing problem only within specific conditions; core network elements having interworking issues only with specific terminals or services, etc.)

There are other related techniques in similar fields, with somewhat different goals and scope. U.S. Pat. No. 8,200,193 relates to anomaly detection in traffic transmitted by a specific terminal, i.e., identifying abnormal traffic generated by a unique terminal, but does not address network level issues and does not focus how to isolate specific problems. U.S. Pat. Nos. 2021/0058424 and 2020/0106795 disclose anomaly detection in telecommunications and/or computer networks that focuses on performance metrics of single elements (microservices or nodes), without taking into consideration the multi-dimensional structure of the network as a system. These systems do no not consider the behavioral distinction between non comparable objects of the network. Other known anomaly detection target solutions target legacy network technologies, typically on the unique node or link level. One example is U.S. Pat. No. 7,460,498, describing a method to detect issues with fixed telecommunication lines. This approach relies on direct measurements of individual network elements but fails to consider the complexity of the whole, interconnected telecommunication system.

### SUMMARY

The present disclosure relates generally to the detection of underperforming network segments using recursive anomaly detection based on separation of communication sessions into homogenous groups according to different dimensions. After collecting KPIs from various network segments and subscriber sessions, attributes corresponding to different dimensions of interest are assigned to the KPIs. During the recursive anomaly detection, the assigned attributes are used to separate the metrics into homogenous groups based on one or more dimensions of interests. Anomaly detection, also referred to as outlier detection, is performed to determine whether a specific homogenous group identified contains anomalous KPIs. These anomalous KPIs may indicate underperforming network segments or elements, interworking issues, or other network anomalies.

A first aspect of the disclosure comprises methods of detecting network anomalies in a communication network. In one embodiment, the method comprises collecting performance metrics indicative of network performance over a plurality of communication sessions, and performing iterative anomaly detection across homogenous groups of the communications session determined based on one or more of the dimensions. Each iteration comprises dividing selected communication sessions into homogenous groups based on a dimension combination comprising one or more of the dimensions, and detecting outliers indicative of network anomalies among the homogenous groups of the selected communication sessions based on statistical analysis of the performance metrics associated with the communication sessions in each of the homogenous groups. The method further comprises outputting dimension combinations of detected network anomalies.

A second aspect of the disclosure comprises a data analytics system configured to detect network anomalies in a communication network. In one embodiment, the data analytics system is configured to collect performance metrics indicative of network performance over a plurality of communication sessions, and perform iterative anomaly detection across homogenous groups of the communications session determined based on one or more of the dimensions. Each iteration comprises dividing selected communication sessions into homogenous groups based on a dimension combination comprising one or more of the dimensions, and detecting outliers indicative of network anomalies among the homogenous groups of the selected communication sessions based on statistical analysis of the performance metrics associated with the communication sessions in each of the homogenous groups. The data analytics system is further configured to comprises outputting dimension combinations of detected network anomalies.

A third aspect of the disclosure comprises a data analytics system configured to detect network anomalies in a communication network. The data analytics system comprises interface circuitry for communicating with network nodes in the communication network and processing circuitry. In one embodiment, the processing circuitry is configured to collect performance metrics indicative of network performance over a plurality of communication sessions and perform iterative anomaly detection across homogenous groups of the communications session determined based on one or more of the dimensions. Each iteration comprises dividing selected communication sessions into homogenous groups based on a dimension combination comprising one or more of the dimensions and detecting outliers indicative of network anomalies among the homogenous groups of the selected communication sessions based on statistical analysis of the performance metrics associated with the communication sessions in each of the homogenous groups. The processing circuitry is further configured to comprises outputting dimension combinations of detected network anomalies.

A fourth aspect of the disclosure comprises a computer program for a data analytics system. The computer program comprises executable instructions that, when executed by processing circuitry in the data analytics system, causes the data analytics system to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 is a schematic diagram of a data analytics system according to an embodiment.

FIG. 2 is a high-level architecture for one implementation the data analytics system.

FIGS. 3A-3C illustrate an example of handover execution time KPIs on measured on different vendor's software separated based on carrier frequency.

FIGS. 4A-4D illustrate an example of average RSRP KPIs measured for different Long Term Evolution (LTE) eNodeBs (eNBs) separated based on cell bandwidth.

FIGS. 5-8 illustrate recursive anomaly detection based on session creation success rate KPIs.

FIG. 9 illustrates persistency detection for detected anomalies.

FIG. 10 illustrates an exemplary method of recursive anomaly detection.

FIG. 11 illustrates a data analytics system configured for recursive system anomaly detection analytics.

FIG. 12 illustrates a cloud implementation of a data analytics system configured for recursive anomaly detection.

FIG. 13 a could framework for implementing a data system configured for recursive anomaly detection.

### DETAILED DESCRIPTION

The present disclosure relates generally to the detection of underperforming network segments using recursive anomaly detection based on separation of communication sessions into homogenous groups according to different dimensions. After collecting KPIs from various network segments and subscriber sessions, attributes corresponding to different dimensions of interest are assigned to the KPIs. During the recursive anomaly detection, the assigned attributes are used to separate the metrics into homogenous groups based on one or more dimensions of interests. Anomaly detection, also referred to as outlier detection, is performed to determine whether a specific homogenous group identified contains anomalous KPIs. These anomalous KPIs may indicate underperforming network segments or elements, interworking issues, or other network anomalies. Generally, the outlier detection determines whether the range of Quality of Service (QoS)/Quality of Experience (QoE) values for the specific group contains a significant portion of abnormal values, i.e., outliers. In subsequent iterations of anomaly detection, homogenous groups found to contain a large number of anomalies can be further divided into smaller homogenous groups according to another dimension of interest and these subgroups can be tested to detect anomalies. This process of separating KPIs into homogenous groups and then testing for anomalies can be repeated to isolate the anomaly. The result of the recursive anomaly detection is a combination of dimensions associated with the network anomalies. The dimension information can be used by network engineers, technicians, and planners to troubleshoot and correct problems in the network. Detected performance degradations are analyzed with respect to their timely behavior, i.e., recurrence or persistency, as well as timely correlation among different anomalies. The detected anomalies can then be ranked by evaluating the impact of the underlying network issues, as well as supports root cause analysis.

A multi-domain, correlated network analytics system offers almost infinite possibilities to investigate various known network failures. But automatic anomaly detection as herein described is necessary to detect the yet unknown failures in the network. The recursive anomaly detection reduces time to detect problems and helps to capture issues in the early, developing phase, minimizing the impact on user experience and network downtimes.

Anomaly detection starts with learning the normal network behavior and has a significant advantage over threshold based alarming systems, because many KPIs depend on time, such as day of the week, or the actual network load. Having thresholds adaptive to these factors significantly increases the reliability of fault detection.

Anomaly detection is performed on homogenous groups. The normal behavior in a multidimensional domain frequently contains network elements or objects that differ in behavior of the range where they can take their values among all the population. Finding these separating dimensions is indispensable to find specific anomalies and problems in the network. Anomaly detection, or outlier detection, can also help isolate under-performing network segments so that the network operator can find lurking elements in the network that correspond to bad average performance in a given area of the network. As one example, the anomaly detection could be used to find the mobile vendor-model pair with network wide low average for call drops.

Monitoring network wide QoS/QoE KPIs in a multi-domain correlated analytics system provides the opportunity to accurately isolate sessions that are adversely impacted by an unidentified failure or interworking issue. Isolation is achieved by finding the most specific filtering of sessions where the most significant deviation from normal behavior is observed. Beyond trivial network elements failures (where fault management or performance management reports indicate the obvious fault), the proposed solution helps find hidden failures and interworking issues in the network by isolating those for specific problems in the network.

The identified and isolated network anomalies and underperforming segments can be correlated through all the possible problems and advantages that the system previously collected and helps to identify trade-offs in the network problems between the advantageous problems allows network operators to evaluate whether an anomaly is a persistent problem for the last time window that the system observed or is a local non persistent outlier for the previous observed time periods.

The data analytics system can gather information about the impact of the identified problem and provide a ranking based on the impacted subscribers and the extension of the problem.

The data analytics system can be run it in a streaming way and with low latency, so all the identified problems are real time actionable and the hardware requirement is low due to low latency.

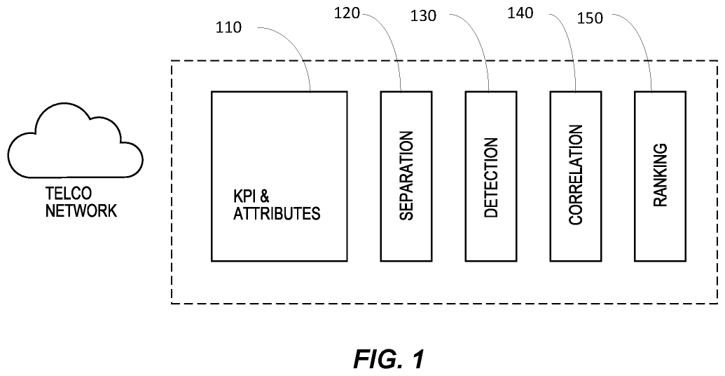

FIG. 1 illustrates a high-level system overview of a data analytics system 100 and shows the main components of the data processing pipeline. The processing pipeline starts with the data collection 110 of KPIs and attributes from the network for all monitored network elements and/or user sessions. The processing proceeds through the four main stages of the data analytics process, separation of homogeneous groups 120, anomaly detection 130, correlation 140 among outliers/anomalies, and ranking 150 to find the most significant performance degradations.

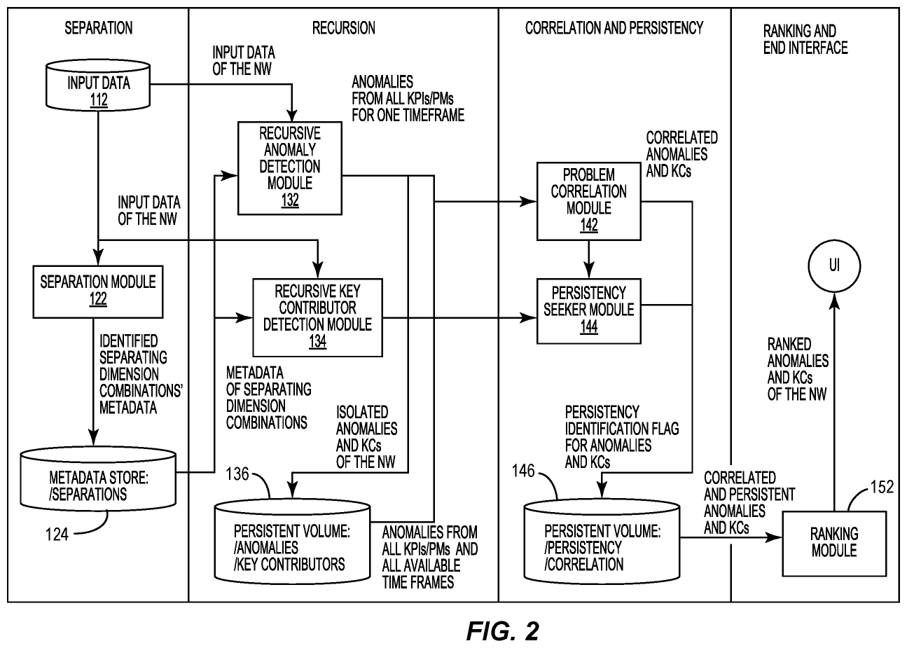

FIG. 2 is a flow chart illustrating one implementation of the data analytics system 100. This implementation is applied to user session-based customer experience metrics and attributes); however it could be easily applied to performance data collected by a performance management counters.

In the following discussion, the various network elements and their attributes that differentiate the collected subscriber sessions are referred to as “dimensions”. Along these network elements, the collected KPIs have a multi-dimensional distribution. Once the average KPI value or its distribution is calculated for a specific network element, the “marginal distribution” of the given KPI is calculated in that specific dimension.

The input data generator module 112 serves as the data source for the data analytics system. This component correlates and aggregates data online for a given granularity (daily, weekly, monthly etc.), grouping for various dimensions at the same time (vendors, models, operating systems, software versions, regions, eNodeB name, cell names, plan-types etc.) or even combinations thereof (vendor-model-operating system-IMEI software version number, functionality-service provider-QCI, tracking area-service provider-functionality, etc.). The input data generator module outputs a large amount of aggregated data with the respective KPI values for each one on the given time granularity.

The input data generator module 112 serves as the input for the whole process, it is the data source for the whole system and should run once the recursive modules are done with their current phase and request another additional dimension, then the module gets triggered and serves these modules with the aggregations.

The input data provided by the input data generator module runs through the separation module 122. The separation module 122 takes the input data from the input data generator and identifies separating dimension combinations from the input schema for any given KPI. The dimensions correspond to attributes of the observed objects in the network. For example, for subscribers a separating dimension can be any mobile device attribute, and for network elements a separating dimension can be vendor, operating frequency, bandwidth, etc.

The separation of KPIs into homogenous groups can be done in several ways. One possible approach is to use Jenk's Natural Break algorithm to find natural breaks in the underlying KPI histogram aggregated on the given dimension or dimension combination. These natural breaks define points that are clustered and have a label of the given dimension or dimension combination value. These clusters can be characterized on two metrics, homogeneity of the cluster and completeness of the label, to measure the distribution of the labels in each cluster. Homogeneity measures how heterogenous is the given cluster for the available labels contained within the cluster. A clustering result satisfies homogeneity if all of its clusters contain only data points which are members of a single class.

Assume that the data set comprises N data points with two partitions: a set of classes, C={cᵢ|i=1, . . . , n} and a set of clusters, K={k_{I}|1, . . . , m}. Let A be the contingency table produced by the clustering algorithm representing the clustering solution, such that A={aᵢⱼ} where aᵢⱼ is the number of data points that are members of class cᵢ and elements of cluster kⱼ. The homogeneity of a cluster can be calculated according to:

$$h = \{ \begin{matrix}1 if H ( C , K ) = 0 \\ 1 - \frac{H ( C \vert K )}{H ( C )} else\end{matrix} \qquad Eq . ( 1 )$$

where:

$$H ( C \vert K ) = - {{\sum }_{k = 1}}^{\vert K \vert} {{\sum }_{c = 1}}^{\vert C \vert} \frac{{1}_{ck}}{N} log \frac{{a}_{ck}}{{{\sum }_{c = 1}}^{\vert C \vert} {a}_{ck}} \qquad Eq . ( 2 )$$

$$and$$

$$H ( C ) = - {{\sum }_{c = 1}}^{\vert C \vert} \frac{{{\sum }_{k = 1}}^{\vert K \vert} {a}_{ck}}{n} log \frac{{{\sum }_{k = 1}}^{\vert K \vert} {a}_{ck}}{n} \qquad Eq . ( 3 )$$

Completeness is symmetrical to homogeneity. In order to satisfy the completeness criteria, a clustering must assign all of those datapoints that are members of a single class to a single cluster. To evaluate completeness, we examine the distribution of cluster assignments within each class. In a perfectly complete clustering solution, each of these distributions will be completely skewed to a single cluster. The completeness of a cluster can be calculated according to:

$$c = \{ \begin{matrix}1 if H ( K , C ) = 0 \\ 1 - \frac{H ( K \vert C )}{H ( C )} else\end{matrix} \qquad Eq . ( 4 )$$

These two metrics can be used to find the dimensions that enable separation of the datapoints into homogenous groups. The output of the clustering is saved as metadata in a metadata store. This information will be used in the recursive anomaly detection.

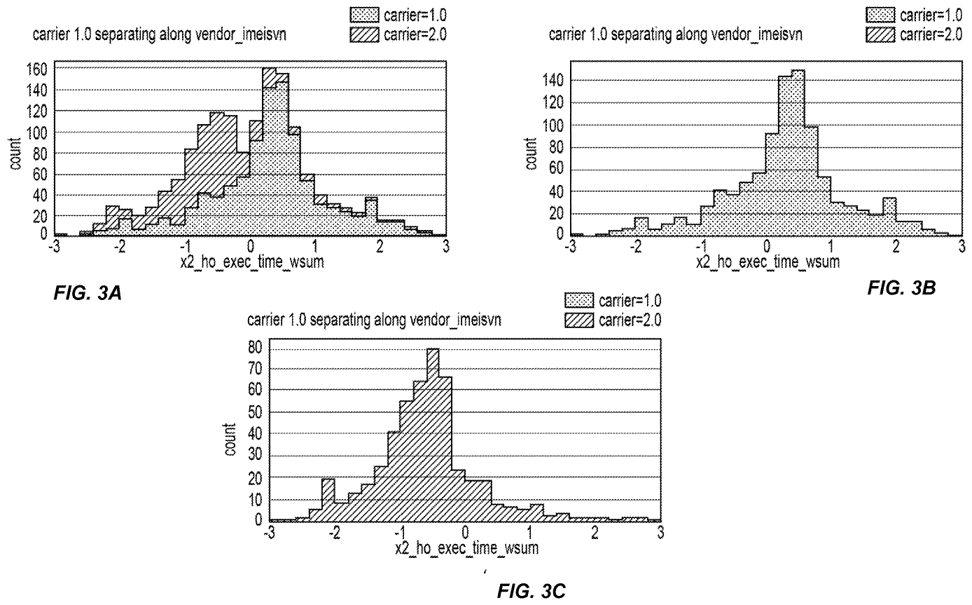

FIGS. 3A-3C illustrate an example of handover execution time KPIs on measured on different vendor's software separated based on carrier frequency.

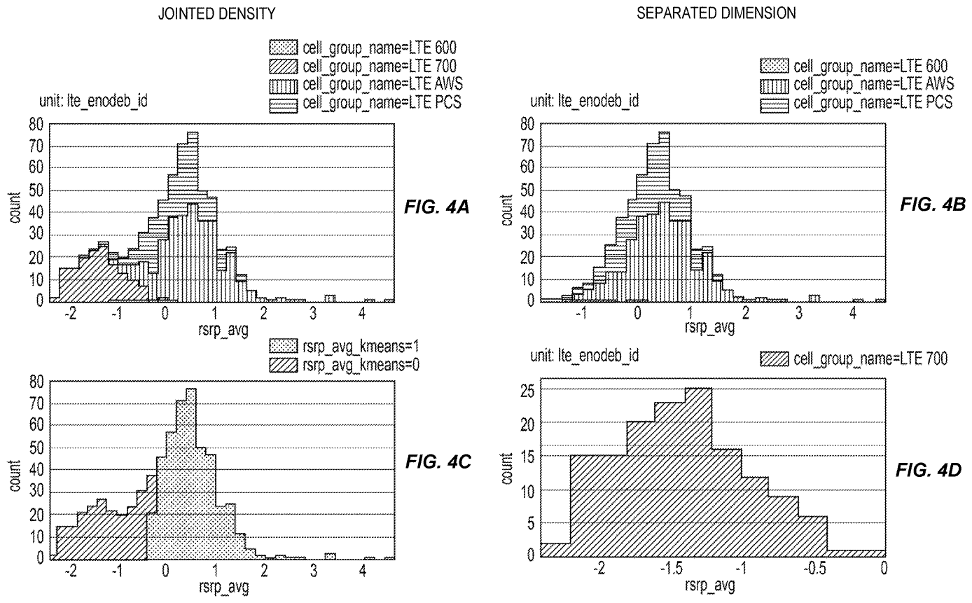

FIGS. 4A-4D illustrate an example of average RSRP KPIs measured for different Long Term Evolution (LTE) eNodeBs (eNBs) separated based on cell bandwidth.

FIG. 2 illustrates two detection modules 132, 134 denoted as recursive anomaly detection 132 and underperforming network segment detection 134. These detection modules 132, 134 consume data from Input data generator and the metadata from the output of separation module 122 as inputs. The detection modules 132, 134 serve as an anomaly isolator in the multidomain network domain, by finding with a top-down or bottom-up logic the most underperforming anomalous element of the network by the given KPI and exposure.

The main difference between the two detection modules 132, 134 lies in how the results are interpreted and used, but the methodology employed for outlier detection is essentially the same. Underperforming network segment detection looks for a larger set of network elements that tend to have lower performance then the “rest” of the network, for example, when the given dimension serves as a “separating dimension” and identifies degraded performance. Anomaly detection identifies individual instances of an anomaly within a supposedly homogenous group. In mathematical terms, both translate to outlier detection. The output of both detection modules 132, 134 are considered network anomalies. Thus, the network anomalies may be associated with unperforming network segments or with interworking issues, or other network problems.

The detection modules 132, 134 are recursive due to their triggering effect with the input data generator. At the starting, the anomaly detection module consumes the basic aggregation of the input data generator module. After isolating the problems on the starting level, the anomaly detection module triggers the separation module 122 again. By focusing/magnifying on the detected anomalies at the tarting level, the detection modules 132, 134 select from the remaining available multidimensions and starts over the detection at the next level.

The anomaly detection can be performed by multiple ways. One approach is to use an ensemble pattern recognition method, that identifies the problems with voters' choice to have a flexible anomaly identifier engine solution. The anomaly isolation problem is then passed through a high pass filter, where the engine focuses to keep medium sized exposure problems in affected subscribers and large exposure problems in measured network performance degradation.

The detection modules 132, 134 output the dimension combinations of the isolated network anomalies, the exposures, the dates and the depth level of the search results for each record in an anomaly database 136.

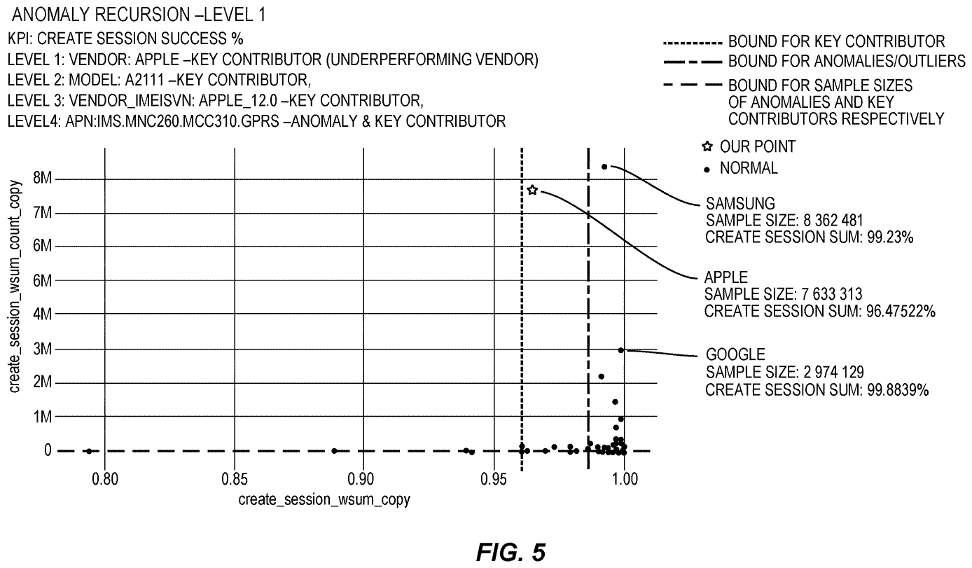

FIGS. 5-8 illustrate an example of the recursive process “digging down” to the root cause of a given anomaly. In this example, the datapoints represent the success rate KPI for a create session request. The vertical line on the left represents a bound for key contributors. The vertical line on the right represents a bound for anomalies/outliers. The two horizontal lines represent sample size bounds for key contributors and anomalies. The sample size boundary for the key contributors is on top and the sample size boundary for the anomalies is on bottom. In FIG. 5, the boundaries are close so as to be nearly indistinguishable. A key contributor should be significant in volume, i.e., number of samples, and high but not extremely high in value. An anomaly can be smaller in volume, i.e., a small non-zero number (and hence a lower bound), and extremely high in value.

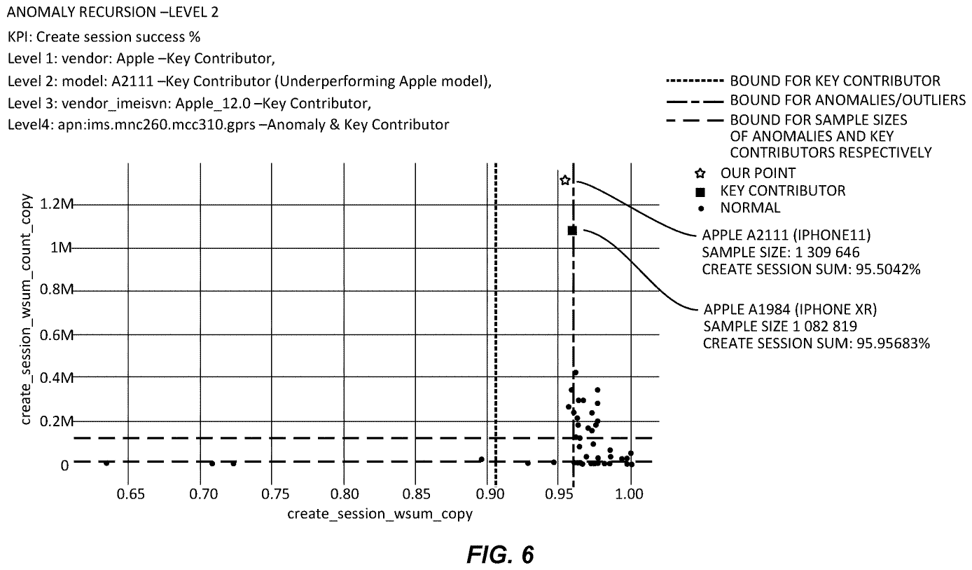

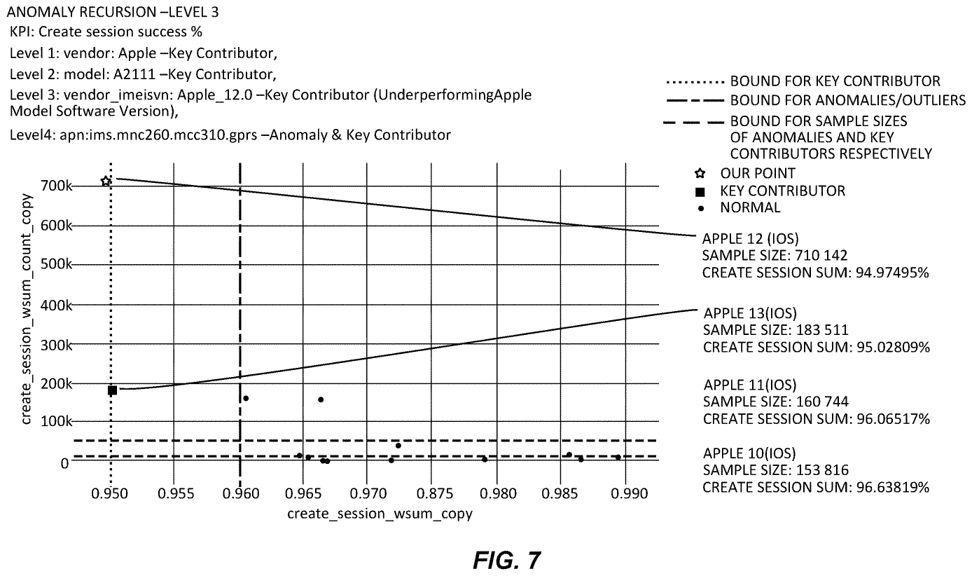

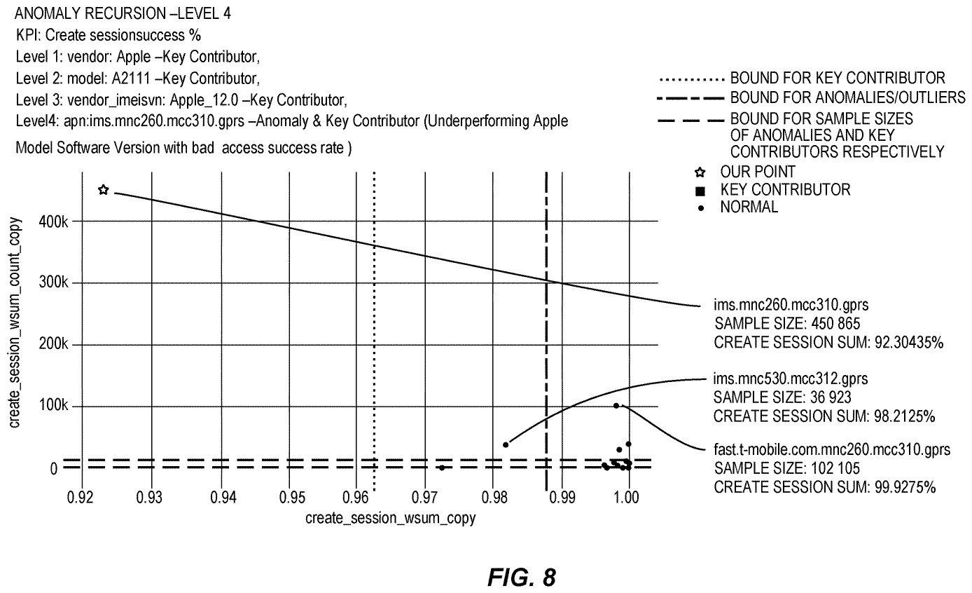

In the first round/level of anomaly detection shown in FIG. 5, the datapoints are grouped based on device vendor. At this level, devices made by Apple appears to be anomalous. At the second level shown in FIG. 6, the datapoints are separated by the model of the device. At this level, the model A211 appears to be anomalous. At the third level shown in FIG. 7, the datapoints are separated by software version. At this level, the Apple 12.0 software version appears to be anomalous. Finally, at the fourth level shown in FIG. 8, the datapoints are separated by location. At this level, a specific geographic area appears to be anomalous.

In this example, the network engineers and technicians are provided with a dimension combination that identifies a potential problem in the network. The network engineers and technicians know that the problem is with a particular model of Apple device using a specific software version in a specific area. Therefore, there appears to be an interworking issue with this particular device/software and the network elements in a specific area. This knowledge helps the network engineers and technicians isolated the specific problem areas in the network. Returning to FIG. 2, after recursive anomaly detection, the problem correlation module 142 is triggered and gathers data from both detection modules 132, 134 for the given time frame that was processed. The problem correlation module 142 works on the output data of these two detection modules 132, 134 and focuses on correlating possible combination tuples. Correlation can be achieved by building an upper triangle adjacency matrix A of the identified negative and positive anomalies. Dimension combinations can be represented as a tuple. For example, the i-th element in the triangle adjacency matrix contains:
(dimension 1: value 1, dimension 2: value 2, . . . , dimension m: value m)

These m-tuples can be thought of as a set and a simple intersection distance can be easily defined, which measures how many of the elements are common in the i-th and in the j-th position of the of the list of the anomalies. One distance metric is given by:

$${a}_{ij} = similarity measure between the i - th and j - th element if i > j$$

Highlighting positive anomalies correlated with network problems help end users to make decisions about any corrective measure by identifying trade-offs in the network that help the end user to have a more nuanced view of the problem's nature. The problem correlation module 142 returns this similarity matrix as an output for the given time period, which is stored in a correlation and persistency database 146.

In parallel with the problem correlation module 142, the persistency seeker module 144 takes as an input the last results for a given time window of recursive anomaly detection module 132 and recursive underperforming network segment detection module 134 as input. The persistency seeker module 144 captures how permanent the given problem is in the network based on the frequency of the anomaly. The user can define thresholds to categorize different frequency levels to be later used for filtering in the ranking module. The persistency seeker module also merges and clears out duplicate problems in the network, to have a unique set of the isolated problems. The categorization can be done by thumb of rule on the proportion of the time window appearances. The output is a persistency database for the given time period.

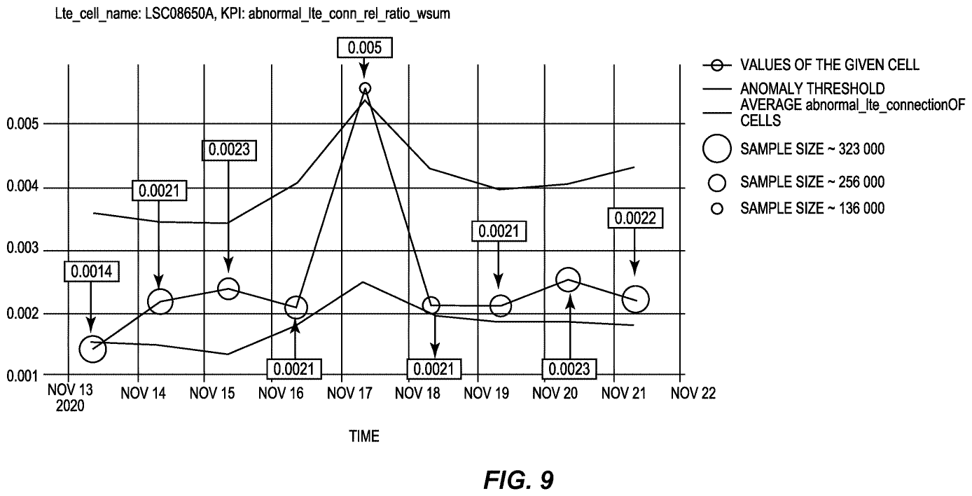

FIG. 9 illustrates an example of persistency determination. FIGS. 5-8 describe the process of finding a “key contributor” (a group of underperformers) or an outlier (an extremely mis-behaving small group or instance) in the data collected by the analytics system. The outlier detection process was works on one “snapshot”, i.e. data collected from the network over a single, pre-defined period (let's say an hourly, daily or weekly aggregate of metrics/KPIs). If a certain element is marked as a key contributor or outlier, it means: that was not following its expected behavior during that period of time. However, it could be a temporary or permanent issue. In the temporary case, when the same outlier detection process is applied for data describing the next time period, the same network element will not be detected as an outlier again (as it “goes back to normal). In the permanent case, when the same outlier detection process is repeated, the given network element appears on the list of detected outliers over and over again. The persistency of the issue could be an important factor when a prioritized list of outliers/anomalies is to be created. In FIG. 9, the depicted cell in this case was crossing the threshold only once, but not on the preceding or following days. So the depicted cell reflects a temporary problem.

In the final step, the anomaly ranking module 150 processes all the collected information from the system, periodically triggered by the persistency seeker module and the problem correlation module. This stage in the workflow highlights the anomalies and key contributors that represent the most impactful problems in the network. The module has a dynamical engine that can be set to any predefined or post-defined target metric with any filtering options. These target metrics can consider problems expansion in distinct subscriber cardinality or can take under consideration both underlying metric's expansion and the expansion of affected users, it can also be filtered to consider persistent problems that were previously identified. The module can take user interactions from the user interface and can manage changes dynamically regarding to requests from the end user.

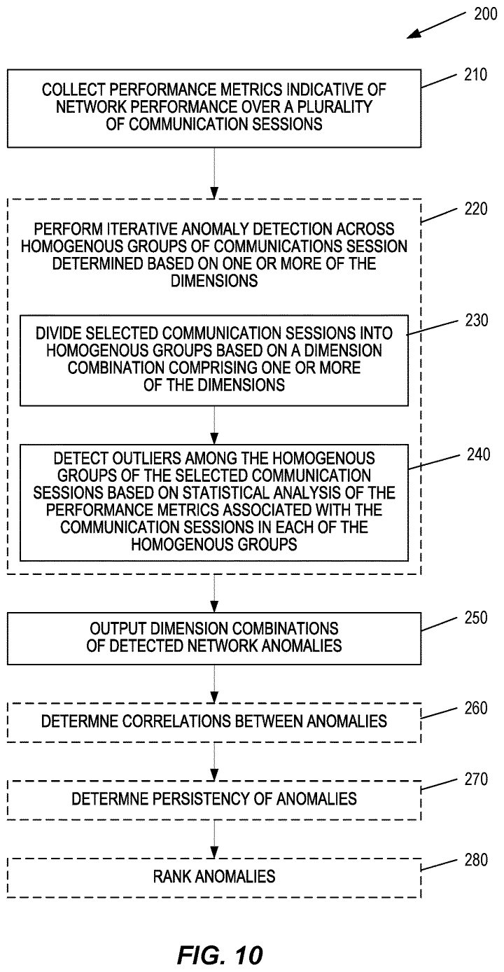

FIG. 10 illustrates an exemplary method 200 of recursive anomaly detection performed by a data analytics system. The data analytics system collects performance metrics indicative of network performance over a plurality of communication sessions (block 210). After collecting data for a period of time, the data analytics system performs iterative anomaly detection across homogenous groups of the communications session determined based on one or more of the dimensions (block 220). During each iteration, the data analytics system divides selected communication sessions into homogenous groups based on a dimension combination comprising one or more of the dimensions (block 230). With the collected data sorted and categorized, the data analytics system detects outliers indicative of network anomalies among the homogenous groups of the selected communication sessions based on statistical analysis of the performance metrics associated with the communication sessions in each of the homogenous groups (block 240). If it is determined that one of the homogenous groups contains anomalies, steps 230 and 240 are repeated using the datapoints in the homogenous group found to contain the anomalies. This process is repeated to isolate the anomaly. Once the recursive anomaly detection is completed, the data analytics system outputs dimension combinations of the detected network anomalies (block 250).

Some embodiments of the method 200 further comprise assigning attributes associated with the one or more dimensions to the performance metrics for classifying the communication sessions.

In some embodiments of the method 200, dividing selected communication sessions into homogenous groups based on the one or more of the dimensions comprises selecting a dimension combination of interest and dividing the selected communication sessions into homogenous groups based on the dimension combination.

In some embodiments of the method 200, the selected communication sessions for an iteration comprises an initial set of communication sessions for a first iteration or a selected subset of the initial set for a subsequent iteration.

In some embodiments of the method 200, dividing selected communication sessions into homogenous groups based on the one or more of the dimensions comprises generating a histogram aggregated on the dimension combination; and determining groups based on the histogram.

In some embodiments of the method 200, detecting outliers indicative of network anomalies comprising detecting underperforming network segments.

In some embodiments of the method 200, detecting outliers indicative of network anomalies comprising detecting anomalous communication sessions.

Some embodiments of the method 200 further comprise correlating the detected network anomalies.

Some embodiments of the method 200 further comprise determining a persistency of the detected network anomalies.

Some embodiments of the method 200 further comprise ranking the detected network anomalies.

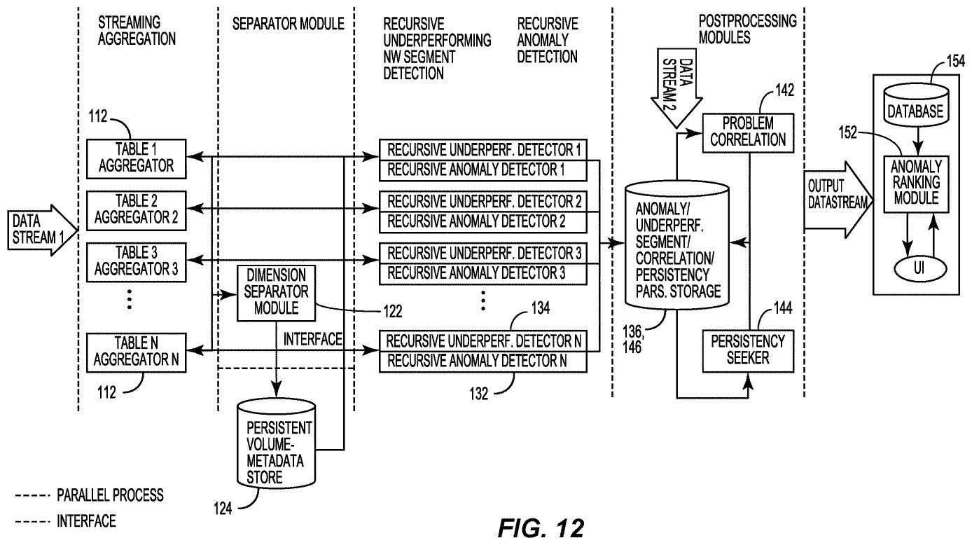

FIG. 12 illustrates a data analytics system 300 according to an embodiment. The data analytics system comprises interface circuit 320 to enable communication with network nodes in a wireless communication network 300, processing circuitry 330 to control the operation of the data analytics system 300, and memory 340 to store computer programs and data needed for operation.

The interface circuitry 320 couples the data analytics system 300 to a communication network for communication with network nodes in the wireless communication network The interface circuitry 320 may comprise a wired or wireless interface operating according to any standard, such as the Ethernet, Wireless Fidelity (WiFi) and Synchronous Optical Networking (SONET) standards.

The processing circuitry 330 controls the overall operation data analytics system 300. The processing circuitry 330 may comprise one or more microprocessors, hardware, firmware, or a combination thereof. The processing circuitry 330 is configured to perform workload scheduling as herein described. In one embodiment, the processing circuitry 330 is configured to perform the method of FIG. 9.

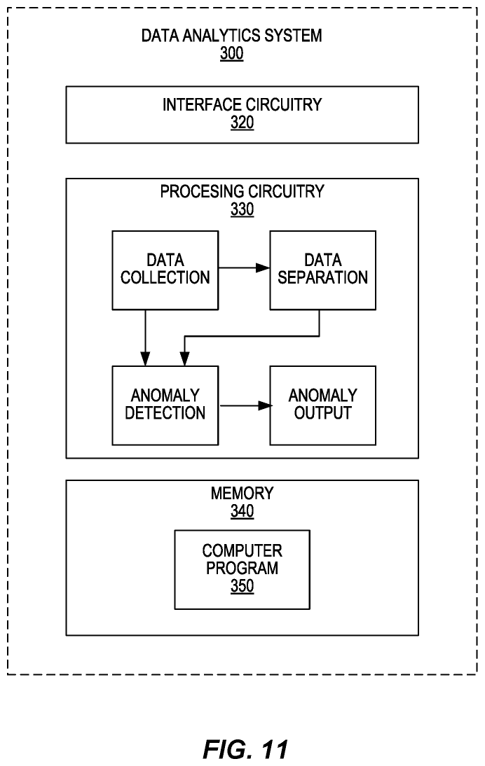

Memory 340 comprises both volatile and non-volatile memory for storing computer program code and data needed by the processing circuitry 330 for operation. Memory 340 may comprise any tangible, non-transitory computer-readable storage medium for storing data including electronic, magnetic, optical, electromagnetic, or semiconductor data storage. Memory 340 stores computer program 350 comprising executable instructions that configure the processing circuitry 330 to implement the method 200 according to FIG. 11 as described herein. A computer program 350 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 350 for configuring the processing circuitry 330 as herein described may be stored in a removable memory, such as a portable compact disc, portable digital video disc, or other removable media. The computer program 350 may also be embodied in a carrier such as an electronic signal, optical signal, radio signal, or computer readable storage medium.

FIG. 12 illustrates a cloud implementation of the data analytics system 100. The cloud implementation follows the same steps as the previously described workflow. The main difference is that interfaces and parallel processes that can be scaled over a cloud environment. and also we add the training and invocation methodology as an example of our implementation.

The data analytics system 100 receives input data through a stream serving module and collects it for a given time period. The stream serving module can be Kafka or any other streaming process. The system then triggers a streaming aggregation, previously described as the input data generator 112, to generate data for given KPI per dimension combinations in N instances. Over these data fragments, the separation module 122 identifies for a given KPI value distribution the underlying separable combinations of the available dimension combinations and writes down these information through an interface to the persistent volume 124 of the system. This persistent volume 124 serves as the metadata store of the system.

The input data generated by input data generator 112 is hand overed to the detection modules 132, 134 for anomaly and underperforming network segment identification using different model types that can be pre-defined in the system. If there are N input data streams, there can be applied at a maximum N model type as well. N this example, it is assumed that there are K model types. Recursive anomaly detection runs parallel, and the number of model types depends on only the resources of the cloud platform. The identified problems of the network are then written back to the persistent storage or metastore 136 of the system 100. The input data from Kafka stream is also collected and written down into the database 124 for correlation purposes. The problem correlation module 142 and the persistency seeker module 144 run parallel on the database or persistent storage querying. Both modules 142, 144 return their output into the database 146.

The collected data and information are transferred via Kafka on an output stream back into a persistent database 154, correlated with the original data of the network system. This persistent database 154 is latter queried by the ranking module 152, which for the end user will trigger the UI for the ranking. All the results at this point can be transferred to a persistent database 154 for the end UI usage.

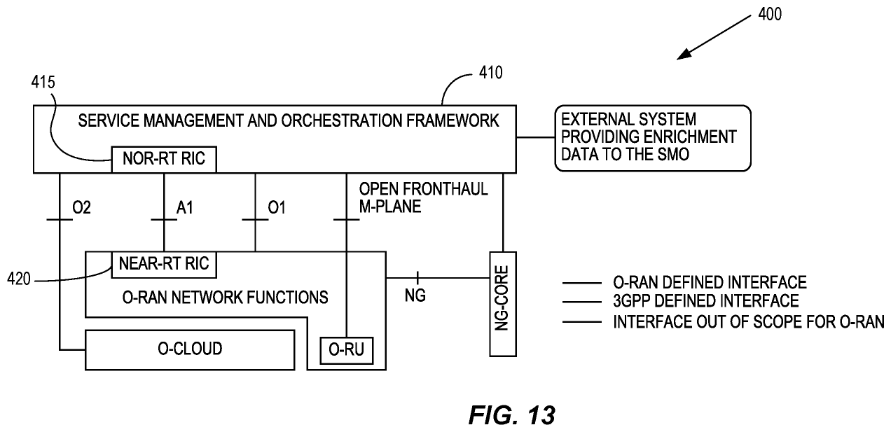

FIG. 13 illustrates an O-RAN network architecture 400 including a Service Management and Orchestration (SMO) component 410. This component incorporates the Non-Real Time Radio Intelligent Controller (Non-RT RIC) functionality 415, where machine learning models can be trained. The trained models can be applied in the Near-Real Time RIC 420 (if transferred over the A1 interface). Alternatively, the trained models can reside in the Non-RT RIC 415 (depending on timing constraints and applications).

The functionality to detect and isolate underperforming network elements or network segments can be implemented within the SMO framework, having its anomaly detection models trained using all the network management and orchestration data including performance metrics (PM), extended with the correlated data sources external to the “core functionality” of SMO, such as the data supporting all the QoE/QoS related use cases of O-RAN. The external system providing enrichment data, combined with configuration management (CM) data provides the “dimensions”, which may be additional attributes or configuration information about network elements.

The proposed system gives the capability to the SMO 410 to automatically detect underperforming network elements and segment, moreover: due to the correlation capabilities, it also capable to detect performance degradations due to interworking issues (when specific combinations of network elements are where issues are detected).

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1-17. (canceled)

18. A method of detecting network anomalies in a communication network, the method comprising:
collecting performance metrics indicative of network performance over a plurality of communication sessions;
performing iterative anomaly detection across homogenous groups of the communications session determined based on one or more of the dimensions, wherein each iteration comprises:
dividing selected communication sessions into homogenous groups based on a dimension combination comprising one or more of the dimensions; and
detecting outliers indicative of network anomalies among the homogenous groups of the selected communication sessions based on statistical analysis of the performance metrics associated with the communication sessions in each of the homogenous groups;
outputting dimension combinations of detected network anomalies.

19. The method of claim 18, further comprising assigning attributes associated with the one or more dimensions to the performance metrics for classifying the communication sessions.

20. The method of claim 19, wherein dividing selected communication sessions into homogenous groups based on the one or more of the dimensions comprises selecting a dimension combination of interest and dividing the selected communication sessions into homogenous groups based on the dimension combination.

21. The method of claim 20, wherein the selected communication sessions for an iteration comprises an initial set of communication sessions for a first iteration or a selected subset of the initial set for a subsequent iteration.

22. The method of claim 18, wherein dividing selected communication sessions into homogenous groups based on the one or more of the dimensions comprises:
generating a histogram aggregated on the dimension combination; and
determining groups based on the histogram.

23. The method of claim 18, wherein detecting outliers indicative of network anomalies comprises detecting underperforming network segments.

24. The method of claim 18, wherein detecting outliers indicative of network anomalies comprises detecting anomalous communication sessions.

25. The method of claim 18, further comprising correlating the detected network anomalies.

26. The method of claim 18, further comprising determining a persistency of the detected network anomalies.

27. The method of claim 18, further comprising ranking the detected network anomalies.

28. A data analytics system configured to detect network anomalies, the data analytics system comprising:
interface circuitry for communicating with one or more entities in a wireless communication network; and
processing circuitry operatively connected to the interface circuitry, the processing circuitry being configured to:
collect performance metrics indicative of network performance over a plurality of communication sessions;
perform iterative anomaly detection across homogenous groups of the communications session determined based on one or more of the dimensions, wherein each iteration comprises:
dividing selected communication sessions into homogenous groups based on a dimension combination comprising one or more of the dimensions; and
detecting outliers indicative of network anomalies among the homogenous groups of the selected communication sessions based on statistical analysis of the performance metrics associated with the communication sessions in each of the homogenous groups;
output dimension combinations of detected network anomalies.

29. A non-transitory computer-readable storage medium containing a computer program comprising executable instructions that, when executed by a processing circuit in a data analytics system causes it to:
collect performance metrics indicative of network performance over a plurality of communication sessions;
perform iterative anomaly detection across homogenous groups of the communications session determined based on one or more of the dimensions, wherein each iteration comprises:
dividing selected communication sessions into homogenous groups based on a dimension combination comprising one or more of the dimensions; and
detecting outliers indicative of network anomalies among the homogenous groups of the selected communication sessions based on statistical analysis of the performance metrics associated with the communication sessions in each of the homogenous groups;
output dimension combinations of detected network anomalies.
